(19) United States
(12) Patent Application Publication
(10) Pub. No.: US 2019/0278406 A1
(43) Pub. Date: Sep. 12, 2019

(54) TOUCH PANEL, TOUCH DISPLAY DEVICE USING SAME, AND METHOD FOR MAKING SAME

(71) Applicants: Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: YUE-FENG YANG, Hsinchu (TW); YEN-HENG HUANG, Hsinchu (TW); PO-LIN CHEN, Hsinchu (TW); HUNG-CHIEH CHIN, Hsinchu (TW); JHE-WEI ZENG, Hsinchu (TW); JU-XIANG LIU, Shenzhen (CN)

(21) Appl. No.: 16/018,165

(22) Filed: Jun. 26, 2018

(30) Foreign Application Priority Data
Mar. 7, 2018 (CN) 201810187083.8

(51) Int. Cl. G06F 3/047; G06F 3/044

(52) U.S. Cl. CPC G06F 3/047; G06F 2203/04103; G06F 2203/04112; G06F 3/044

(57) ABSTRACT

A touch panel, comprising: a substrate; a plurality of sensing electrodes on the substrate, each of the plurality of sensing electrodes being formed by a plurality of metal meshes; and a plurality of traces on the substrate, the plurality of traces electrically coupled to the plurality of sensing electrodes, and each of the plurality of traces are a metal wire; wherein a blackening layer is formed on each of the plurality of sensing electrodes, and no blackening layer is formed on the plurality of traces. The blackening layers of the touch panel of the present invention only cover the sensing electrodes and do not cover the traces, which can avoid chemical substances remaining on the traces and traces being corroded and disconnection when the black layers are manufactured.

### FIELD

The subject matter herein generally relates to a touch panel, a touch display device using the touch panel, and a method for making the touch panel.

### BACKGROUND

A touch panel generally includes a plurality of sensing electrodes for sensing touch position and a plurality of traces for connecting the sensing electrodes to a driving IC. In order to overcome the visibility problem of the touch panel, a blackening layer is required to be formed on the sensing electrodes and the traces. The method for forming the blackening layer may include forming a metal layer as the blackening layer on the surface of the sensing electrodes and the traces by chemical reaction. However, when the blackening layer is formed using this method, chemical substances may remain on the traces and react with the traces, which cause the traces corrosion and disconnection.

Therefore, there is room for improvement in the art.

### BRIEF DESCRIPTION OF THE DRAWINGS

Implementations of the present technology will now be described, by way of example only, with reference to the attached figures.

FIG. 1 is a top view of a touch panel according to an embodiment of the present disclosure.

FIG. 2 is a cross-sectional view of FIG. 1 taken along line II-II.

FIG. 3 is an exploded view of a touch display device according to an embodiment of the present disclosure.

FIG. 4 through FIG. 8 are views showing a method for making a touch panel according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series, and the like.

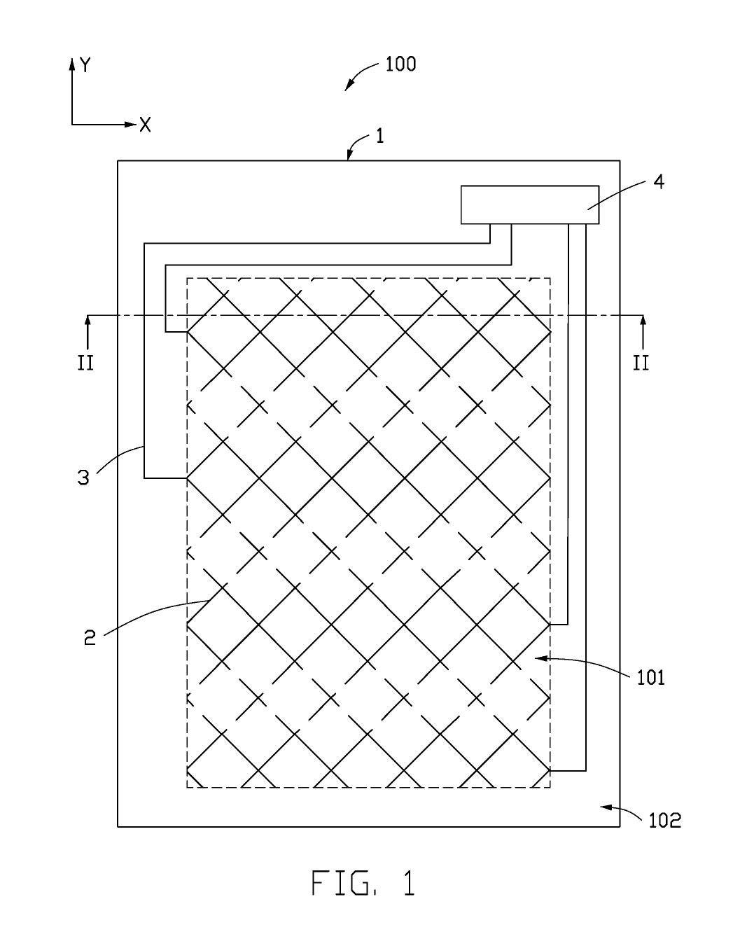

FIG. 1 illustrates a touch panel 100. The touch panel 100 can be applied to electronic devices having touch panels, such as personal digital assistants (PDAs), laptop computers, and smart phones.

In this embodiment, the touch panel 100 is a capacitive touch panel. As shown in FIG. 1, the touch panel 100 defines a central area 101 for receiving touch operations and a perimeter area 102 surrounding the central area 101. The touch panel 100 comprises a substrate 1 and a plurality of sensing electrodes 2 formed on the substrate 1. The plurality of sensing electrodes 2 are located in the central area 101 and configured for sensing touch operations. In this embodiment, each sensing electrode 2 is composed of a plurality of metal meshes formed by a plurality of metal lines intersected with each other, so that the sensing electrodes 2 can allow light to pass through. In this embodiment, a plurality of dummy lines 20 is located between the sensing electrodes 2 to avoid moirë effects. The touch panel 100 further comprises a plurality of traces 3 in the perimeter area 102. The traces 3 and the sensing electrodes 2 are formed on the same surface of the substrate 1, and the traces 3 are electrically coupled between the sensing electrodes 2 and a driver circuit 4.

The substrate 1 is made of an insulating material. The material of the substrate 1 may be selected from a transparent glass, a transparent quartz or a transparent plastic. For example, in an embodiment, the substrate 1 includes one or more of Polyether sulfone (PES), Polyethylene naphthalate (PEN), Polyethylene (PE), Polyimide (PI), Polyvinyl chloride (PVC), Polyethylene terephthalate (PET). In other embodiments, the substrate 1 may be made of ceramic or silicon. Further, the substrate 1 may be made of a flexible material.

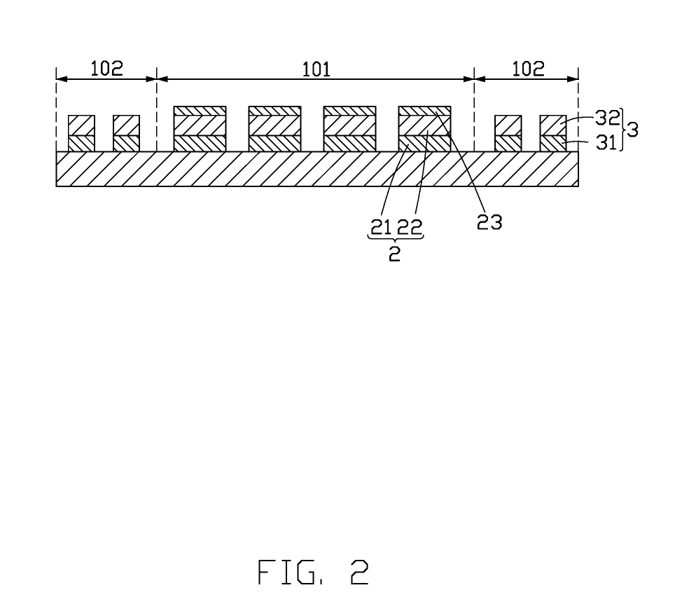

Only a part of the plurality of sensing electrodes 2 is shown in FIG. 2. Each sensing electrode 2 comprises a first conductive layer 22. In this embodiment, the plurality of sensing electrodes 2 may be formed by electroless plating. In other embodiments, the plurality of sensing electrodes 2 may also be formed by other conventional manufacturing methods, such as chemical vapor deposition (CVD). In this embodiment, each sensing electrode 2 comprises two layers. Each sensing electrode 2 may further comprise a first catalyst layer 21, and the first catalyst layer 21 is formed in direct contact with a surface of the substrate 1. Each first conductive layer 22 may be formed on one first catalyst layer 21 by electroless plating. Each first conductive layer 22 is formed on a side of one first catalyst layers 21 opposite from the substrate 1. In other embodiments, depending on the manufacturing process of the sensing electrodes 2, each of the plurality of sensing electrodes 2 may further comprise a photoresist layer (not shown) or comprise only the first conductive layer 22. In this embodiment, the plurality of first catalyst layers 21 may be made of at least one selected from a group consisting of Palladium (Pd), Rhodium (Rh), Platinum (Pt), Iridium (Ir), Osmium (Os), Gold (Au), Nickel (Ni), and Iron (Fe). The plurality of first conductive layers 22 may be made of at least one selected from a group consisting of Aluminum (Al), Silver (Ag), Gold (Au), Cobalt (Co), Chromium (Cr), Copper (Cu), Indium (In), Manganese (Mn), Molybdenum (Mo), Nickel (Ni), Neodymium (Nd), Palladium (Pd), Platinum (Pt), Titanium (Ti), Tungsten (W), and Zinc (Zn). In this embodiment, the plurality of first conductive layers 22 are made of copper.

In this embodiment, the touch panel 100 further comprises a plurality of blackening layers. Each blackening layer 23 is formed on one sensing electrode 2. In this embodiment, each blackening layer 23 is formed on one first conductive layer 22. The blackening layers 23 may be made of metal oxide. In this embodiment, the blackening layers 23 are made of copper oxide (CuOₓ). It can be understood that the blackening layers 23 may be made of metal, for example, Platinum (Pt). In this embodiment, the first conductive layers 22 can sense the touch operations, and the blackening layers 23 can overcome the visibility problem of the first conductive layers 22.

Each trace 3 comprises a second conductive layer 32. In this embodiment, the plurality of traces 3 may be made by electroless plating. In other embodiments, the plurality of traces 3 may also be made by other available manufacturing methods, such as chemical vapor deposition (CVD). In this embodiment, each trace comprises two layers, one second catalyst layer 31 and one second conductive layer 32. Each second conductive layer 32 may be formed on the second catalyst layer 31 by the electroless plating. The second catalyst layer 31 is made on a side of the second catalyst layer 31 opposite from the substrate 1. In other embodiments, depending on the manufacturing process of the traces 3, each trace 3 may further comprise a photoresist layer (not shown) or comprise only the second conductive layer 32. In this embodiment, the plurality of second catalyst layers 31 may be made of at least one selected from a group consisting of Palladium (Pd), Rhodium (Rh), Platinum (Pt), Iridium (Ir), Osmium (Os), Gold (Au), Nickel (Ni), and Iron (Fe). The plurality of second conductive layers 32 may be made of at least one selected from a group consisting of Aluminum (Al), Silver (Ag), Gold (Au), Cobalt (Co), Chromium (Cr), Copper (Cu), Indium (In), Manganese (Mn), Molybdenum (Mo), Nickel (Ni), Neodymium (Nd), Palladium (Pd), Platinum (Pt), Titanium (Ti), Tungsten (W), and Zinc (Zn). In this embodiment, the plurality of second conductive layers 32 are made of copper.

In this embodiment, the plurality of first catalyst layers 21 and the plurality of second catalyst layers 31 are in a same layer, and the plurality of first conductive layers 22 and the plurality of second conductive layers 32 are in a same layer. The plurality of first catalyst layers 21 and the plurality of second catalyst layers 31 can be formed by a same manufacturing process, and the plurality of first conductive layers 22 and the plurality of second conductive layers 32 can be formed by a same manufacturing process.

In this embodiment, each sensing electrode 2 is covered with the blackening layer 23, and each trace 3 is not covered with the blackening layers 23. Therefore, in the touch panel 100, a reflectivity of a combination of each of the plurality of sensing electrodes 2 and the blackening layer 23 is different from a reflectivity of each of the plurality of the traces 3, and the reflectivity of the combination of each of the plurality of sensing electrodes 2 and the blackening layer 23 is smaller than the reflectivity of each of the plurality of the traces 3. Optionally, in one embodiment, the reflectivity of each of the plurality of the traces 3 is greater than 10% of that of the combination of each of the plurality of sensing electrodes 2 and the blackening layer 23. When the touch panel 100 is incorporated in an electronic device (not shown), an ink layer (not shown) may be provided at a position of a cover of the electronic device corresponding to the perimeter area 102 of the touch panel 100, to cover the traces 3 and prevent the traces 3 from being observable by the user of the electronic device.

In this embodiment, each blackening layer 23 is formed on the first conductive layer 22 by a chemical reaction. Since each trace 3 does not include the blackening layer 23, the traces 3 will not be etched even if chemical substances remain in the process of the above chemical reaction, and the disconnection of the traces 3 can be avoided. Even if chemical substances may remain on the plurality of sensing electrodes 2 and cause the sensing electrodes 2 being etched slightly, it will not affect the implementation of the touch sensing function of the touch panel 100.

It can be understood that the touch panel 100 comprises a protective layer (not shown) covering the plurality of sensing electrodes 2 and the plurality of traces 3, the protective layer is used to protect the plurality of sensing electrodes 2 and the plurality of traces 3.

It can be understood that the touch panel 100 may comprises a plurality of second sensing electrodes and a plurality of second traces formed on the other surface of the substrate 1. In an embodiment, the structures of the plurality of sensing electrodes 2 and the plurality of second sensing electrodes are basically the same, and the structures of the plurality of traces 3 and the plurality of second traces are basically the same. It can be understood that the structures of the plurality of sensing electrodes 2 and the plurality of second sensing electrodes may also be different, and the structures of the plurality of traces 3 and the plurality of second traces may also be different, as long as the sensing electrodes 2 and the second sensing electrode can cooperate to sensing touch operation, and the traces 3 and the second traces can be electrically coupled between the sensing electrodes 2 and the second sensing electrodes.

It can be understood that the plurality of sensing electrodes 2 and the plurality of second sensing electrodes are not limited to be formed on two opposite surfaces of the substrate 1. In other embodiments, the plurality of sensing electrodes 2 and the plurality of second sensing electrodes may be formed on different substrates or on the same surface of the same substrate.

The present disclosure also provides a touch display device 1000 using the touch panel 100 described above.

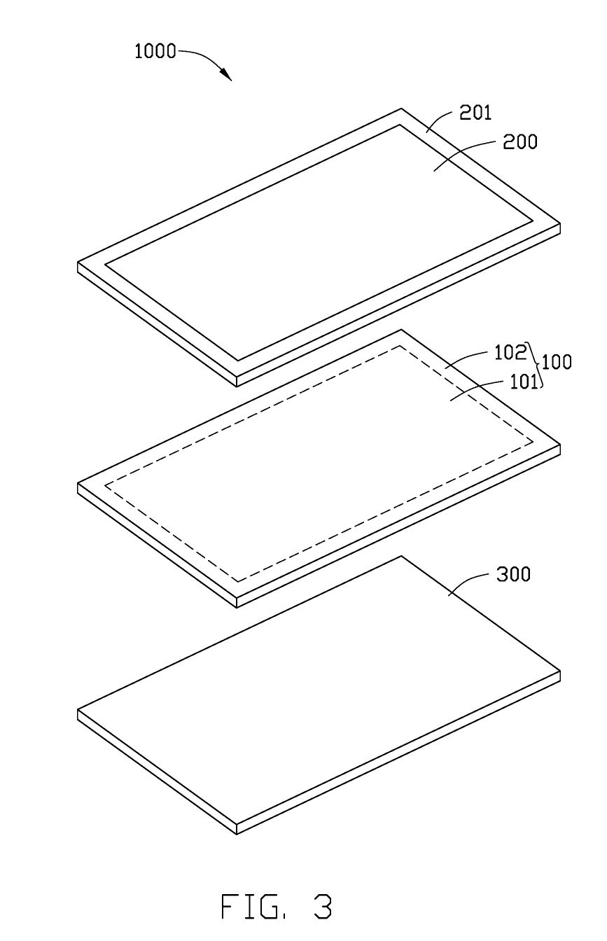

As shown in FIG. 3, the touch display device 1000 comprises a cover 200, a touch panel 100, and a display panel 300. The cover 200, the touch panel 100, and the display panel 300 are stacked in that order. The touch panel 100 is between the cover 200 and the display panel 300. The cover 200 is provided with an ink layer 201 corresponding to the perimeter area 102 of the touch panel 100, in order to prevent the plurality of traces 3 from being observable by the user of the touch display device 1000.

The present disclosure further provides a method for making a touch panel 100. The following manufacturing method will only explain a plurality of sensing electrodes 2 and a plurality of traces 3 as an example. The manufacturing method of a plurality of second sensing electrodes and a plurality of second traces is the same as that of the plurality of sensing electrodes 2 and the plurality of traces 3.

The method for making a touch panel 100 may include one or more of the following steps.

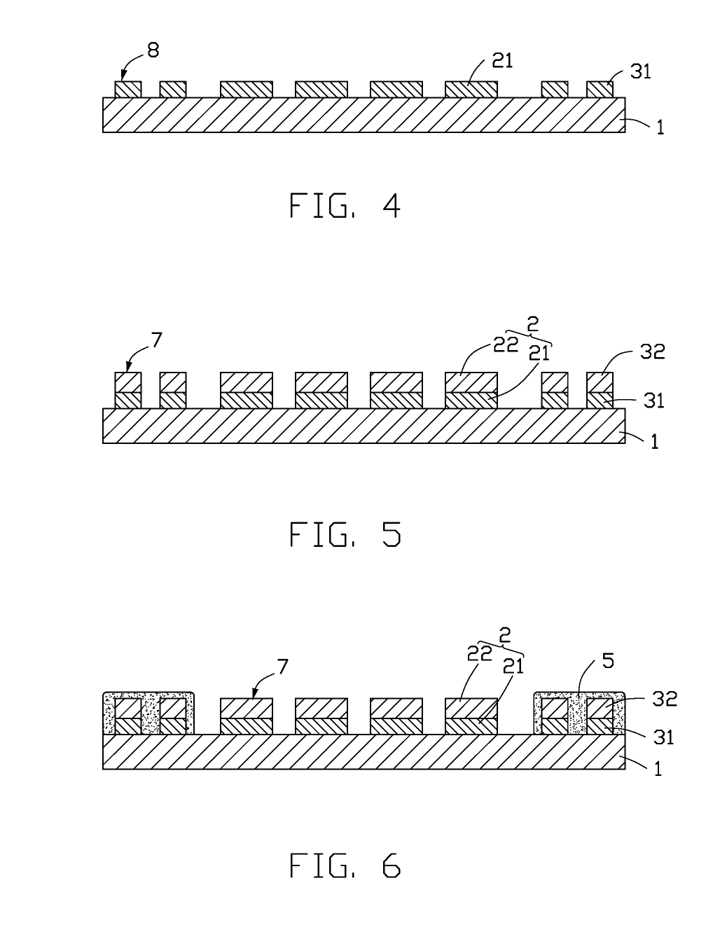

Step 1: As shown in FIG. 4 and FIG. 5, a substrate 1 is provided. The substrate 1 defines a central area 101 and a perimeter area 102. A conductive layer 7 is formed on a surface of the substrate 1 and patterned to form a plurality of sensing electrodes 2 in the central region 101 and a plurality of traces 3 in the perimeter area 102.

In this embodiment, the conductive layer 7 in the central region 101 defines as a plurality of first conductive layers 22, and the conductive layer in the perimeter area 102 defines as a plurality of second conductive layers 32. Each first conductive layer 22 serves as a sensing electrode 2, and each second conductive layer 32 serves as a trace 3. The conductive layer 7 is made by electroless plating. In other embodiments, the conductive layer 7 may also be made by other methods, such as chemical vapor deposition (CVD). Since the first conductive layer 22 and the second conductive layer 32 are manufactured by electroless plating in this embodiment, step 1 may further include forming a catalyst layer 8 on the substrate 1 (as shown in FIG. 4) before the plurality of first conductive layers 22 and the plurality of second conductive layers 32 are formed. A portion of the catalyst layer 8 in the central area 101 is converted to form the first catalyst layers 21 and the first conductive layers 22 on the first catalyst layers 21. Each first conductive layer 22 is formed on one of the first catalyst layers 21 by electroless plating. Portions of the catalyst layer 8 in the perimeter area 102 is converted to form the second catalyst layers 31 and the second conductive layers 32 on the second catalyst layers 31. Each second conductive layer 31 is formed on one of the second catalyst layers 32 by electroless plating (as shown in FIG. 4). It can be understood that in this embodiment, the plurality of first catalyst layers 21 and the plurality of second catalyst layers 31 are formed by a same material layer, and the first conductive layers 22 and the second conductive layers 32 are formed by a same material layer.

Step 2: As shown in FIG. 6, a photoresist layer 5 is formed on the plurality of traces 3.

The photoresist layer 5 covers only the traces 3 and does not cover the sensing electrodes 2. The material of the photoresist layer 5 is not limited to any specific material. In other embodiments, an etching resist ink layer (not shown) may be used.

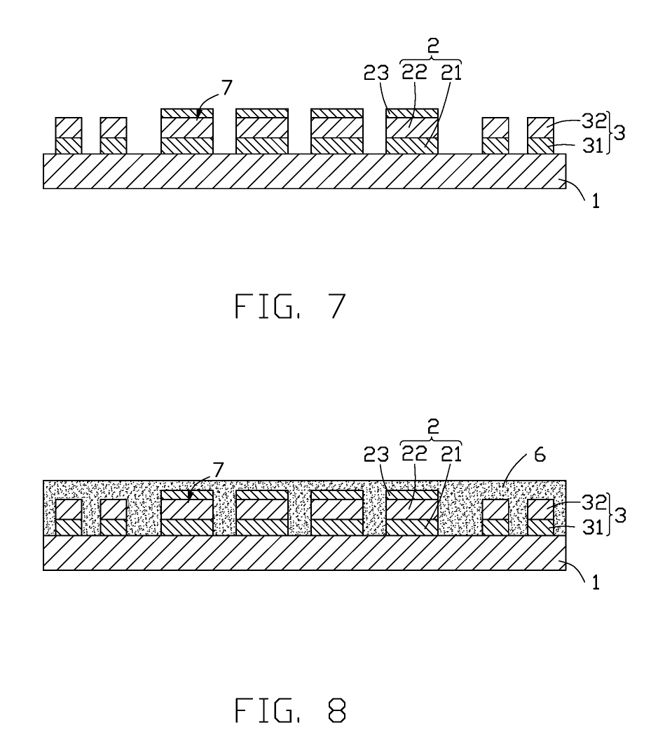

Step 3: As shown in FIG. 7, a blackening layer 23 is formed on a side of each sensing electrode 2 opposite from the substrate 1, and then the photoresist layer 5 is removed.

The blackening layer 23 may be formed by an oxidizing reaction or electroless plating. For example, in this embodiment, copper oxide (reddish brown) is oxidized to form copper oxide (dark blue green). In other embodiments, the blackening layers 23 may be formed by electroplating the first conductive layers 22, for example, copper (red brown) may be electroplated to form a thin layer of platinum (black) covering the copper surface. Since each trace 3 is covered with the photoresist layer 5, the trace 3 is not covered by the blackening layer 23.

Step 4: As shown in FIG. 8, a protective layer 6 is formed on the plurality of sensing electrodes 2 and the plurality of traces 3.

The protective layer 6 is made of an insulating material, which can protect the plurality of sensing electrodes 2 and the plurality of traces 3 from being damaged during assembly and use of the touch panel 100.

Through step 1 to step 4, it can be obtained a touch panel 100 that the sensing electrodes 2 are covered with the blackening layer 23, and the traces 3 are not covered with the blackening layer 23, and the traces 3 are not easily broken.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A touch panel, comprising:
a substrate;
a plurality of sensing electrodes on the substrate, each of the plurality of sensing electrodes being formed by a plurality of metal meshes; and
a plurality of traces on the substrate, the plurality of traces electrically coupled to the plurality of sensing electrodes, and each of the plurality of traces are a metal wire; and
wherein a blackening layer is formed on each of the plurality of sensing electrodes, and no blackening layer is formed on the plurality of traces.

2. The touch panel of claim 1, wherein:
each of the plurality of sensing electrodes comprises a first conductive layer on the substrate, and the blackening layer is on a surface of the first conductive layer opposite from the substrate; and
each of the plurality of traces includes a second conductive layer, the plurality of first conductive layers and the plurality of second conductive layers are formed by a same material layer.

3. The touch panel of claim 1, wherein a reflectivity of a combination of each of the plurality of sensing electrodes and the blackening layer is less than a reflectivity of each of the plurality of traces.

4. A method for making a touch panel, comprising:
providing a substrate, the substrate defining a central area and a perimeter area;
forming a conductive layer on a surface of the substrate and patterning the conductive layer to form a plurality of sensing electrodes in the central region and a plurality of traces in the perimeter area;
forming a photoresist layer covering the plurality of traces;
forming a blackening layer on each of the plurality of sensing electrodes; and
removing the photoresist layer.

5. The method of claim 4, wherein the conductive layer is formed by electroless plating.

6. The method of claim 4, wherein the blackening layer is formed by an oxidizing reaction.

7. The method of claim 4, wherein the blackening layer is formed by electroplating.

8. The method of claim 4, wherein a reflectivity of a combination of each of the plurality of sensing electrodes and the blackening layer is less than a reflectivity of each of the plurality of traces.

9. A touch display device, comprising a touch panel, the touch panel comprising:
a substrate;
a plurality of sensing electrodes on the substrate, each of the plurality of sensing electrodes being formed by a plurality of metal meshes; and
a plurality of traces on the substrate, the plurality of traces electrically connected to the plurality of sensing electrodes, and each of the plurality of traces are a metal wire;
wherein a blackening layer is formed on each of the plurality of sensing electrodes, and
no blackening layer is formed on the plurality of traces.

10. The touch display device of claim 9, wherein:
each of the plurality of sensing electrodes comprises a first conductive layer on the substrate, and the blackening layer is on a surface of the first conductive layer away from the substrate; and
each of the plurality of traces includes a second conductive layer, the plurality of first conductive layers and the plurality of second conductive layers are formed by a same material layer.

11. The touch display device of claim 9, wherein a reflectivity of a combination of each of the plurality of sensing electrodes and the blackening layer is less than a reflectivity of each of the plurality of traces.
